(19) United States
(12) Patent Application Publication
(10) Pub. No.: US 2005/0251289 A1
(43) Pub. Date: Nov. 10, 2005

(54) Medicament dispenser

(76) Inventors: Stanley George Bonney, RESEARCH TRIANGLE PARK, NC (US); Michael Birsha Davies, Ware (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/522,319

(22) PCT Filed: Jul. 23, 2003
(86) PCT No.: PCT/EP03/08149

§ 371 Date: Jan. 25, 2005

(30) Foreign Application Priority Data
Jul. 25, 2002 (GB) 0217199.9
Nov. 21, 2002 (GB) 0227145.0

(51) Int. Cl. G06F 17/00; G07F 11/00; G06F 17/60

(52) U.S. Cl. 700/244; 700/236; 705/3; 221/7; 221/2

(57) ABSTRACT

A medicament dispenser device for use in the delivery of a combination medicament product is disclosed. The device includes a first medicament container for containing a first medicament component; a first release means for releasing the contents of the first medicament container; at least one further medicament container for containing at least one further medicament component; and at least one further release means for releasing the contents of each said at least one further medicament container. The first medicament component is kept separate from the at least one further medicament component until the point of release thereof for delivery in combination. The dispenser device can additionally include at least one actuation indicator associated with the first medicament container and the at least one further medicament container.

### TECHNICAL FIELD

The present invention relates to a medicament dispenser for dispensing medicament combination products. The invention particularly relates to a medicament dispenser including an electronic control system for controlling the dispensing of combination medicament products.

### BACKGROUND TO THE INVENTION

The use of inhalation devices in the administration of medicaments, for example in bronchodilation therapy is well known. Such devices generally comprise a body or housing within which a medicament carrier is located. Known inhalation devices include those in which the medicament carrier is a blister strip containing a number of discrete doses of powdered medicament. Such devices usually contain a mechanism of accessing these doses, usually comprising either piercing means or means to peel a lid sheet away from a base sheet. The powdered medicament can then be accessed and inhaled. Other known devices include those in which the medicament is delivered in aerosol form, including the well known metered dose inhaler (MDI) delivery devices. Liquid-based inhaler devices are also known.

Therapies involving combinations of different and complementary active medicaments are known. These can be administered by a delivery device either as distinct combination (i.e. multi-active) medicament products, which comprise a defined mixture of each component medicament, or as groups of single active medicament products, which are designed to be taken in combination or sequentially. Whilst combination products offer added convenience for the patient, certain medicament actives are difficult to co-formulate into distinct combination products. For example, the actives may interact chemically with each other in an undesirable way when formulated together.

It is thus, desirable in certain circumstances, to have a medicament dispenser that separately (i.e. in isolated fashion) contains each active component of a combination product, but which enables the delivery of a combined dose in response to a minimum number of patient actions. In particular, it is desirable that each active component of the combined dose is delivered to the patient in a single, combined dose in response to a single patient dosing action. For example, it is desirable that a combined product for inhalation be delivered in response to a single patient actuation of an inhaler, even where the active components of that combined product are separately stored within the inhaler device.

The Applicants have also observed that particular medicaments can be more suited to delivery to by particular types of inhaler device. For example, one particular medicament may be more suitable for delivery by an MDI device, whereas another may be more suitable for delivery by a DPI device. That suitability may for example, be driven by ease of formulation of the medicament for that particular inhaler device or by the delivery and pharmaceutical performance characteristics obtainable when the particular inhaler device is employed. Unitary devices comprising different types of dispenser are thus, envisaged.

The Applicants have now devised a combination medicament dispenser device arranged to accommodate separately located active components in which an electronic dispensing control system is employed. In one aspect, this provides the ability to vary the composition of the multi-active component ‘combined product’ by controlling the relative ratio of release of its component parts and therefore to enable ‘tailored dosing’ of combination product to the patient.

### SUMMARY OF THE INVENTION

According to one aspect of the present invention there is provided a medicament dispenser for use in the delivery of a combination medicament product to a patient, the dispenser comprising

a first medicament container for containing a first medicament component;

a first release means for releasing the contents of said first medicament container;

at least one further medicament container for containing at least one further medicament component; and

at least one further release means for releasing the contents of each said at least one further medicament container;

wherein the first medicament component is kept separate from the at least one further medicament component until the point of release thereof for delivery in combination, and wherein the dispenser additionally comprises

an electronic control system for controlling the release of contents from the first and at least one further medicament container.

The contents from the first and at least one further medicament container are released as a combination product (i.e. combining the first medicament component and the at least one further medicament component) for delivery to the patient.

Suitably, the electronic control system provides the ability to vary the relative ratio of contents released from each medicament container and thereby enables ‘tailored’ release of (variably formulated) combination product to the patient.

Suitably, the first medicament component and the at least one further medicament component are non-identical medicaments. In aspects, the first medicament container and at least one further medicament container are arranged (e.g. sized, shaped, designed) to contain the respective non-identical medicament components.

In aspects, each separate medicament component may be arranged for simultaneous or sequential release from the one or more medicament containers, although in general where components are released sequentially the time delay between release of each separate medicament component is short (e.g. milliseconds) to ensure that a combination product is provided for delivery to the patient.

Suitably, in combination, the first medicament and at least one further medicament comprise a defined combination product. That is to say, that when combined together the distinct active medicament doses released by actuation of the device form a dose of a ‘multi-active’ medicament treatment.

On actuation, the dispenser device is designed to deliver a dose portion of the first medicament and a dose portion of each at least one further medicament. The term ‘dose portion’ is employed because in the context of the invention the distinct ‘portions’ are brought together on delivery to form a combination (i.e. multi-active) product dose.

In one particular aspect, the first medicament container contains plural co-formulation compatible medicament components, and each at least one further medicament container contains at least one co-formulation incompatible medicament component.

The term ‘co-formulation compatible’ herein is used to mean compatible in the sense of being amenable to co-formulation, perhaps even displaying synergetic co-formulation characteristics. The term ‘co-formulation incompatible’ is used to mean the reverse, that is to say for whatever reason including chemical or physical incompatibility or simply lack of synergetic characteristics or benefits, the medicament components are either non-amenable to co-formulation or for whatever reason, including for development simplicity, preferably not co-formulated.

In one particular aspect, the dispenser device is designed to receive a first and only one further medicament container (i.e. two medicament containers only).

The first and at least one further medicament containers may be of a similar-type or in aspects, be of a different type. This enables additional flexibility in that one container may for example, accommodate a product in dry powder form whereas the other container accommodates product in liquid, solution or aerosol form.

In one aspect, the first medicament container and the at least one further medicament container are of a type adapted to be used with a medicament dispenser selected from the group consisting of a reservoir dry powder inhaler (RDPI), a multi-dose dry powder inhaler (MDPI), a metered dose inhaler (MDI) and a liquid spray inhaler (LSI). The first medicament dispenser and at least one further remain different in type.

In one aspect, the first medicament dispenser is a reservoir dry powder inhaler (RDPI), and the at least one further medicament dispenser is of a type selected from the group consisting of a multi-dose dry powder inhaler (MDPI), a metered dose inhaler (MDI) and a liquid spray inhaler (LSI).

In another aspect, the first medicament dispenser is a multi-dose dry powder inhaler (MDPI), and the at least one further medicament dispenser is of a type selected from the group consisting of a reservoir dry powder inhaler (RDPI), a metered dose inhaler (MDI) and a liquid spray inhaler (LSI).

In a further aspect, the first medicament dispenser is a metered dose inhaler (MDI), and the at least one further medicament dispenser is of a type selected from the group consisting of a reservoir dry powder inhaler (RDPI), a multi-dose dry powder inhaler (MDPI) and a liquid spray inhaler (LSI).

In a further aspect, the first medicament dispenser is a liquid spray inhaler (LSI), and the at least one further medicament dispenser is of a type selected from the group consisting of a reservoir dry powder inhaler (RDPI), a multi-dose dry powder inhaler (MDPI) and a metered dose inhaler (MDI).

By reservoir dry powder inhaler (RDPI) it is meant an inhaler having a reservoir form container pack suitable for containing multiple (un-metered doses) of medicament product in dry powder form and including means for metering medicament dose from the reservoir to a delivery position. The metering means may for example comprise a metering cup, which is movable from a first position where the cup may be filled with medicament from the reservoir to a second position where the metered medicament dose is made available to the patient for inhalation.

By multi-dose dry powder inhaler (MDPI) is meant an inhaler suitable for dispensing medicament in dry powder form, wherein the medicament is comprised within a multi-dose container pack containing (or otherwise carrying) multiple, define doses (or parts thereof) of medicament product. In a preferred aspect, the carrier has a blister pack form, but it could also, for example, comprise a capsule-based pack form or a carrier onto which medicament has been applied by any suitable process including printing, painting and vacuum occlusion.

In one aspect, the multi-dose pack is a blister pack comprising multiple blisters for containment of medicament product in dry powder form. The blisters are typically arranged in regular fashion for ease of release of medicament therefrom.

In one aspect, the multi-dose blister pack comprises plural blisters arranged in generally circular fashion on a disc-form blister pack. In another aspect, the multi-dose blister pack is elongate in form, for example comprising a strip or a tape.

Preferably, the multi-dose blister pack is defined between two members peelably secured to one another. U.S. Pat. Nos. 5,860,419, 5,873,360 and 5,590,645 in the name of Glaxo Group Ltd describe medicament packs of this general type. In this aspect, the device is usually provided with an opening station comprising peeling means for peeling the members apart to access each medicament dose. Suitably, the device is adapted for use where the peelable members are elongate sheets that define a plurality of medicament containers spaced along the length thereof, the device being provided with indexing means for indexing each container in turn. More preferably, the device is adapted for use where one of the sheets is a base sheet having a plurality of pockets therein, and the other of the sheets is a lid sheet, each pocket and the adjacent part of the lid sheet defining a respective one of the containers, the device comprising driving means for pulling the lid sheet and base sheet apart at the opening station.

By metered dose inhaler (MDI) it is meant a medicament dispenser suitable for dispensing medicament in aerosol form, wherein the medicament is comprised in an aerosol container suitable for containing a propellant-based aerosol medicament formulation. The aerosol container is typically provided with a metering valve, for example a slide valve, for release of the aerosol form medicament formulation to the patient. The aerosol container is generally designed to deliver a predetermined dose of medicament upon each actuation by means of the valve, which can be opened either by depressing the valve while the container is held stationary or by depressing the container while the valve is held stationary.

Where the medicament container is an aerosol container, the valve typically comprises a valve body having an inlet port through which a medicament aerosol formulation may enter said valve body, an outlet port through which the aerosol may exit the valve body and an open/close mechanism by means of which flow through said outlet port is controllable.

The valve may be a slide valve wherein the open/close mechanism comprises a sealing ring and receivable by the sealing ring a valve stem having a dispensing passage, the valve stem being slidably movable within the ring from a valve-closed to a valve-open position in which the interior of the valve body is in communication with the exterior of the valve body via the dispensing passage.

Typically, the valve is a metering valve. The metering volumes are typically from 10 to 100 μl, such as 25 μl, 50 μl or 63 μl. Suitably, the valve body defines a metering chamber for metering an amount of medicament formulation and an open/close mechanism by means of which the flow through the inlet port to the metering chamber is controllable. Preferably, the valve body has a sampling chamber in communication with the metering chamber via a second inlet port, said inlet port being controllable by means of an open/close mechanism thereby regulating the flow of medicament formulation into the metering chamber.

The valve may also comprise a ‘free flow aerosol valve’ having a chamber and a valve stem extending into the chamber and movable relative to the chamber between dispensing and non-dispensing positions. The valve stem has a configuration and the chamber has an internal configuration such that a metered volume is defined therebetween and such that during movement between is non-dispensing and dispensing positions the valve stem sequentially: (i) allows free flow of aerosol formulation into the chamber, (ii) defines a closed metered volume for pressurized aerosol formulation between the external surface of the valve stem and internal surface of the chamber, and (iii) moves with the closed metered volume within the chamber without decreasing the volume of the closed metered volume until the metered volume communicates with an outlet passage thereby allowing dispensing of the metered volume of pressurized aerosol formulation. A valve of this type is described in U.S. Pat. No. 5,772,085.

By liquid spray inhaler (LSI) it is meant a medicament dispenser suitable for dispensing medicament in spray form, wherein the medicament is typically formulated in liquid or solution form and comprised in a liquid container. The container is typically provided with a means of metering to a spray generator, which imparts energy to the liquid or solution, thereby generating a spray for inhalation by the patient. The spray generator, in aspects, comprises a vibrating element (e.g. a mesh) that provides vibrational energy to the formulation, thereby resulting in its aerosolisation. In other aspects, the spray generator comprises a pump mechanism, which either delivers the medicament directly to the patient (as a liquid spray) or which delivers the medicament to an intermediate position at which further energy is supplied thereto to further propel, aerosolise or otherwise direct the medicament dose to the patient.

The first release means and the at least one further release means may either be independently operable or operable in coupled fashion.

The medicament dispenser device herein has unitary form, and typically has a housing shaped to receive, and enable the release of medicament product from the first and at least one further medicament containers.

In one aspect, the housing integrally comprises a release means for releasing medicament from at least one, preferably all of the medicament dispensers. Suitably, the release means for each medicament container is coupled, thereby enabling simultaneous delivery of medicament from each dispenser in response to a single patient actuation step.

In another aspect, the housing is shaped to receive the medicament containers, each of which is provided with respective release means. In this case, the release means have typically been adapted for receipt by the housing. The medicament dispenser and release means therefor are in one aspect, supplied as independently operable ‘cassette refills’ for the unitary device.

The medicament dispenser includes an electronic control system for controlling the release of contents from the first and at least one further medicament container. The electronic control system may have any suitable form and incorporate any of the electronic system aspects as described hereinafter.

In one aspect, the electronic control system is responsive to inputs directly provided to it by an individual such as for example, a medical professional (e.g. G.P.), a pharmacist or the patient. In this aspect, any tailoring of the composition of the combination product is determined by these inputs. In one particular aspect, the inputs are set (or even, pre-set) at particular time such as at the prescription of the dispenser to the patient.

In another aspect, the electronic control system is associated with or responsive to a patient diagnostic system that collects diagnostic information relating to the patient's current disease condition. Tailoring of the composition of the combination product is therefore determinable by reference to diagnostic data gathered and processed by this system.

In one aspect, the patient diagnostic system herein comprises detecting means for detecting one or more marker(s) indicative of a disease state. In aspects, the markers may be chemical, biochemical or physical markers.

In one aspect, the patient diagnostic system comprises
(i) detecting means for detecting one or more marker(s) indicative of disease condition; and
(ii) diagnostic processing means for processing information obtainable from the detecting means.

Suitably, the medicament dispenser further comprises sampling means for use in diagnostic sampling. The sampling means is thus for example, adapted to sample the patient's breath, skin, sweat, urine, blood or other bodily fluid for diagnostic purposes. Suitably, the sampling means directs the patient's sample into the detecting means. The sampling means may comprise for example a mouthpiece into which the patient exhales or any other sampling means suitable for sampling the particular fluid or bodily excretion.

Where the dispenser is an inhaler for dispensing medicament for the relief of respiratory disorders, further examples of suitable diagnostic data would include diagnostics related to the patient's physical breath characteristics including particularly breath cycle data or peak flow or FEV-1 data.

In one aspect, the electronic control system and patient diagnostic system are integrated in a single dispenser device. The dispenser device is suitably configured as a portable or handheld device.

In another aspect, the patient diagnostic system is provided as an attachment to the dispenser device. Suitably, communication (e.g. via a docking interaction) exists between the patient diagnostic system and the electronic control system.

In a further aspect, the patient diagnostic system is remote to the dispenser device. Suitably, communication (e.g. via wireless means) exists between the patient diagnostic system and the electronic control system.

In one particular aspect, the detecting means comprises sensing means, for example a chemical sensor, biosensor or physical sensor that is able to specifically detect one or more given chemical, biochemical or physical characteristics. In general terms, ‘biosensor’ means a sensor, which responds to the presence of one or more particular biochemical markers and converts it into a correlated measurable signal.

In another aspect, the detecting means comprises spectroscopic detecting means for direct spectroscopic detection of one or more chemical or biochemical marker(s). In variations, the spectroscopic detecting means are used in combination with one or more biosensors.

Suitably, the patient diagnostic system comprises electronic diagnostic processing means for processing information obtainable from the detecting means.

Suitably, the electronic diagnostic processing means comprises a micro-controller with associated analogue and digital electronics, and interfaces. The electronic processing means receives the output electronic signal from the detecting means, amplifying it and converting it into appropriate analogue or digital signal format at an electronic interface. By analysing the signal using an appropriate analogue computer (circuitry), or using appropriate algorithms (software) in the case of a digital computer, a biomarker specific response can be determined, and correlated with the extent and severity of the disease at that time. The quantity of each medicament of the combination product required to treat the disease can then be determined based on the efficacy of each drug and optimum response of the dosing curve at the severity level of the disease as measured. The correlation between the disease status and the control parameters for drug dosing may be pre-determined from clinical studies and pre-stored in the device, in the form of a series of electronic circuit settings (analogue system), or data stored in the memory in the case where a digital system is being used.

If the output signal from the detection means is not an electrical signal, for example the signal is light (fluorescence spectra, absorption, luminescence etc), heat, acoustic, etc., an appropriate detector based on a corresponding principle (photo-electric, thermoelectric, or acousto-electric, etc.) is used to convert the signal into an electrical signal before it is connected to the above described electronics amplification, signal conditioning and processing electronics for further analysis.

The micro-controller is typically a Single-Chip-Computer, which is a miniature computer fabricated on a single semiconductor chip, containing central processing unit (CPU), on board memories (e.g. RAM and EPROM), and appropriate interfaces (e.g. timer/counter, parallel digital interfaces, A/D, D/A interface). The single-chip-computer can be programmed through a system development kit. Using such a kit, appropriate components, such as a working-clock oscillator, resistors, and capacitors etc, can be tested and wired with the computer to allow the desired functions and the software programme tested before it is ‘permanently’ fixed onto the memory within the computer for system control and performing mathematical analysis. The computer will directly convert the analogue signal from the detection means into digital signals and perform mathematical analysis to extract all necessary information from the signal, comparing the measured result with the results stored in the computer database (e.g. stored within a suitable Look up table), decide and control subsequent actuation via sending out appropriate control electrical signal to the actuator. The system will also be able to display the result via associated LED or LCD, or other display devices and communicate with other database systems via a series/parallel interface for record and for telemedicine purpose.

Alternately, a micro-controller can be developed based on a single-board-computer, which integrates a central processing unit (CPU), memories (e.g. RAM, EPROM), and interfaces (A/D, D/A, Counter/Timers, etc.) on to a single printed circuit board. It functions in much the same manner as the single-chip-computer.

Alternatively, an analogue computer is used in place of a digital single-chip or single-board computer and the signal is processed in an all-analogue form. Corresponding control signals for driving actuation mechanisms and result display are also all analogue signals. Communication with other systems is achieved via appropriate interfaces.

Suitably, there is provided an electronic data management system that is either integral with or communicates with the electronic control system. The electronic data management system typically has input/output capability and comprises a memory for storage of data; a microprocessor for performing operations on said data; and a transmitter for transmitting a signal relating to the data or the outcome of an operation on the data.

Suitably, the electronic data management system additionally comprises a data input system for user input of data to the electronic data management system. Preferably, the data input system comprises a man machine interface (MMI) preferably selected from a keypad, voice recognition interface, graphical user interface (GUI) or biometrics interface.

Suitably, the electronic data management system is adapted to receive and process data relating to initial settings of any feature; medicament-related prescribing data; and data relating to the patient. The data is, for example, input to the data management system by the doctor, nurse, pharmacist or even the patient or it may be factory pre-set. Examples of patient-related data for inputting could for example, include the age, sex, bodyweight and the general medical/prescription history of the patient. Examples of medicament-related data could include the ‘standard’ dosage regime and permissible variations within that regime.

Energy may be conserved by a variety of means to enable the system to operate for longer on a given source of energy, such as a battery. Energy.conservation or saving methods have additional advantages in terms of reducing the size requirements of the power source (e.g. battery) and thus the weight and portability of the medicament dispenser.

A variety of energy saving methods is available which generally involve reducing power consumption. One such method is to use a clock or timer circuit to switch the power on and off at regular or predetermined intervals. In another method the system can selectively switch on/off specific electronic components, such as visual display units or sensors, in order to power these devices only when they are required to perform a particular sequence of events. Thus different electronic components may be switched on and off at varying intervals and for varying periods under control of the system. The power sequencing system may also respond to a sensor, such as a motion or breath sensor, which is activated on use of the device.

Low power or “micropower” components should be used within the electronics where possible and if a high power device is required for a particular function this should be put into a low power standby mode or switched off when not required. Similar considerations apply in the selection of transducers. Operation at low voltage is desirable since power dissipation generally increases with voltage.

For low power digital applications complementary metal oxide semi-conductor (CMOS) devices are generally preferred and these may be specially selected by screening for low quiescent currents. Clock speeds of processors and other logic circuits should be reduced to the minimum required for computational throughput as power consumption increases with frequency. Supply voltages should also be kept at minimal values consistent with reliable operation because power dissipation in charging internal capacitance's during switching is proportional to the square of the voltage. Where possible, supply voltages should be approximately the same throughout the circuit to prevent current flowing through input protection circuits. Logic inputs should not be left floating and circuits should be arranged so that power consumption is minimised in the most usual logic output state. Slow logic transitions are undesirable because they can result in relatively large class-A currents flowing. Resistors may be incorporated in the power supply to individual components in order to minimise current in the event of failure.

In some control applications, components that switch between on and off states are preferred to those that allow analogue (e.g. linear) control because less power is dissipated in low resistance on states and low current off states. Where linear components are used (e.g. certain types of voltage regulators) then types with low quiescent currents should be selected. In some circuit configurations it is preferable to use appropriate reactive components (i.e. inductors and capacitors) to reduce power dissipation in resistive components.

Suitably, there is provided a visual display unit for display of data from the diagnostic processing means and/or electronic data management system to the user. The display may for example, comprise a screen such as an LED or LCD screen. More preferably the visual display unit is associable with the body of the medicament dispenser.

Suitably, the medicament dispenser additionally comprises a datalink for linking to a local data store to enable communication of data between the local data store and the electronic data management system. The datastore may also comprise data management, data analysis and data communication capability.

The datastore may itself form part of a portable device (e.g. a handheld device) or it may be sized and shaped for accommodation within the patient's home. The datastore may also comprise a physical storage area for storage of replacement medicament containers. The datastore may further comprise an electrical recharging system for recharging any electrical energy store on the medicament dispenser, particularly a battery recharging system.

The datalink may for example enable linking with a docking station, a personal computer, a network computer system or a set-top box by any suitable method including a hard-wired link, an infrared link or any other suitable wireless communications link.

In one aspect, the medicament dispenser includes an electronic dose reminder system. This may be configured to have any suitable form and may be powered by mains, stored (e.g. battery) or self-regenerating (e.g. solar) energy power source.

The electronic dose reminder system comprises an electronic timer for timing an elapsed time period corresponding to the time since the last actuation of the device; a dose interval memory for storing data relating to a prescribed dose interval time period; and a patient alerter for alerting a user. The alerter activates when the elapsed time period exceeds the prescribed dose interval time period.

The electronic timer progressively times the period since the last actuation of the medicament dispensing means (the ‘elapsed time period’). The timer can have any suitable electronic form. The significance of the ‘elapsed time period’ is that in use, it typically corresponds to the time elapsed since the previous dose delivery event.

The timer may be configured to include an automatic re-zeroing feature such that on subsequent actuation of the device the timer count starts again from zero.

The dose interval memory stores data relating to a prescribed dose interval time period. By way of examples, if the medicament is to be taken twice a day at a regular interval, the prescribed dose interval may be set as twelve hours, or for a once daily treatment the value may be set at twenty four hours. In aspects, the system may be configured to allow for ready readjustment of the prescribed dose interval time period, or it may be configured in secure fashion such that any readjustment may be made only by a designated prescriber (e.g. a medical professional or pharmacist). Password and/or other security means may be employed. The prescribed dose interval may be configured to be variable over a particular course of treatment, or alternatively it may be fixed at a set dose interval over the full course of treatment. The patient alerter is designed to communicate an alert to the user. The alerter activates only when the holding time period exceeds the prescribed dose interval time period. By way of an example, for a once daily treatment with a prescribed dose interval of twenty four hours, the alerter would activate only when the holding time period, as timed by the electronic timer, exceeds twenty four hours since at this point another dose is due to be taken. It may thus, be appreciated that the alerter acts functionally as a reminder to the patient that a dose is due to be taken.

The alerter may in aspects, comprise a visual device, such as a liquid crystal display (LCD) or an array of light-emitting diodes (LEDs), connected to a battery-driven timing device of any convenient kind known to those skilled in the art. The visual device may be configured to display information such as the actual time or the elapsed time from the taking of a previous dosage and may have superimposed thereon additional messages, such as a textual instruction to take a dose of the medicament. Alternatively, the instruction to take the medicament may be conveyed merely by displaying a warning colour or by causing the display to flash or in any other way.

In a further alternative arrangement, no specific time or elapsed time information is displayed, but the alerter merely provides a warning signal that indicates the necessary action to the user.

Depending upon the lifestyle of the user, additional or alternative warnings may be of greater assistance than purely visual warnings. Accordingly, it is envisaged that the alerter may provide audible and/or tactile warnings, such as vibration, instead of (or in addition to) visual warnings.

The alerter may provide a single, one-off alert. More preferably, the alerter is configured to provide the alert over a set period of time (the ‘alerting time period’ or ‘alerting window’). In one aspect, the alerting time period is calculated as a function of (e.g. fraction of) the dose interval time period. For example, for a twice-daily treatment with a dose interval time period of twelve hours, the alerting time period may be set as half that period (i.e. six hours). In this case, the alert is then provided for the six hours immediately following the activation of the alert.

The reminder system is typically configured such that the alerting signal cuts off when the user removes the medicament delivery device from the holder to enable dosing of medicament therefrom. The system is then reset. Other manual cutoffs/overrides may also be included.

A suitable power source such as a battery, clockwork energy store, solar cell, fuel cell or kinetics-driven cell will be provided as required to any electronic component herein. The power source may be arranged to be rechargeable or reloadable.

Suitably, the medicament dispenser additionally comprises one or more sensors for sensing environmental conditions, particularly those conditions which may affect the patient's therapeutic needs. Thus, ambient temperature, humidity, air pollution, ozone and other similar factors may be sensed. The readings may simply be arranged for display to the patient or in aspects, may be factored into the dosage calculation, perhaps after receipt of a specific confirmation by the patient that such factoring in is to be applied.

Suitably, the medicament dispenser additionally comprises a communicator for wireless communication with a network computer system to enable transfer of data between the network computer system and the electronic data management system. Dispensers employing such communicators are described in pending PCT Applications No.s PCT/EP00/09291 (PG3786), PCT/EP00/09293 (PG4029) and PCT/EP00/09292 (PG4159). Preferably, the communicator enables two-way transfer of data between the network computer system and the electronic data management system.

Suitably, the data is communicable between the network computer system and the electronic data management system in encrypted form. All suitable methods of encryption or partial encryption are envisaged. Password protection may also be employed. Suitably, the communicator employs radiofrequency or optical signals.

In one aspect, the communicator communicates via a gateway to the network computer system. In another aspect, the communicator includes a network server (e.g. a web server) such that it may directly communicate with the network.

In a further aspect, the communicator communicates with the gateway via a second communications device. Preferably, the second communications device is a telecommunications device, more preferably a cellular phone or pager. Preferably, the communicator communicates with the second communications device using spread spectrum radiofrequency signals. A suitable spread spectrum protocol is the Bluetooth (trade mark) standard, which employs rapid (e.g. 1600 times a second) hopping between plural frequencies (e.g. 79 different frequencies). The protocol may further employ multiple sending of data bits (e.g. sending in triplicate) to reduce interference.

In one aspect, the network computer system comprises a public access network computer system. The Internet is one suitable example of a public access network computer system, wherein the point of access thereto can be any suitable entrypoint including an entrypoint managed by an Internet service provider. The public access network computer system may also form part of a telecommunications system, which may itself be a traditional copper wire system, a cellular system or an optical network.

In another aspect, the network computer system comprises a private access network computer system. The private access network system may for example, comprise an Intranet or Extranet that may for example, be maintained by a health service provider or medicament manufacturer. The network may for example include password protection; a firewall; and suitable encryption means.

Preferably, the communicator enables communication with a user-specific network address in the network computer system.

The user-specific network address may be selected from the group consisting of a web-site address, an e-mail address and a file transfer protocol address. Preferably, the user-specific network address is accessible to a remote information source such that information from said remote information source is made available thereto. More preferably, information from the user-specific network address can be made available to the remote information source.

In one aspect, the remote information source is a medicament prescriber, for example a doctor's practice. Information transferred from the medicament prescriber may thus, comprise changes to prescription details, automatic prescription updates or training information. Information transferred to the medicament prescriber may comprise compliance information, that is to say information relating to the patient's compliance with a set-prescribing programme.

Suitably, the electronic data management system includes a dose memory (e.g. look up table form) for storing dosage data and reference is made to the dose memory in calculating the optimum amount of each medicament in the combination product to dispense.

The medicament dispensing system comprises a first and at least one further medicament container, each associated with release means for releasing a quantity (e.g. volume or mass) of medicament in response to the electronic control system.

The quantity of medicament to be dispensed (i.e. dose setting) is in one aspect, automatically controlled by the electronic control system (e.g. via an appropriate interface and electromechanical systems or micro electromechanical system-MEMS).

In another aspect, the quantity of medicament to be dispensed is set manually by the patient responsive to dose guidance determined by the electronic control system and indicated to the patient (e.g. visually, on an electronic display).

In one aspect, the quantity of medicament for dispensing is metered from a reservoir of medicament (e.g. in powder or fluid form) by use of any suitable metering means.

Suitably, the meter comprises a valve (for example, a linear or rotary valve) and/or a piston and/or a load cell. In another aspect, the meter comprises a plunger, such as might exist in a syringe.

Suitably, the meter comprises at least one metering cavity or chamber. In one embodiment, the or each metering chamber is reversibly moveable into fluid communication with the reservoir for metering therefrom.

In one embodiment, the meter and the reservoir are relatively rotatable with respect to each other about a common central axis. Preferably, the or each metering cavity or chamber is adapted to be in fluid communication selectively with the reservoir or with the patient.

The or each metering cavity or chamber may have a variable volume. Alternatively, the or each metering cavity or chamber may have a fixed volume which is variable by insertion of a plunger or piston. The or each metering cavity or chamber may be formed from expandable material and/or have a telescopic or concertina arrangement.

In one aspect, the dispenser is provided with mixing means for ensuring mixing of the delivered medicaments prior to their delivery to the patient (e.g. by inhalation) as a ‘mixed’ multi-active combination product.

Suitably, the mixing means comprises a mixing chamber including inlets for receiving medicament form each medicament container and an outlet for delivery of ‘mixed’ medicament product to the patient for inhalation (e.g. through a mouthpiece which communicates with the mixing chamber). The ergonomics of the mixing chamber will be arranged to ensure effective mixing of the separate medicament feeds. In aspects, baffles, propellers, venturi and other features for controlling mixing dynamics are provided. The mixing chamber may also be provided with energisation means for energising the mixing process, or alternatively features may be provided to harness the energy provided by a patient's inward breath to enhance the mixing process.

The dispenser device is suitably provided with means for varying the amount of medicament product released from each medicament container (e.g. in response to the electronic control system). Customized delivery of combination medicament product may therefore be achieved through varying the relative ratios of each individual medicament product delivered as well as by varying the absolute amount of medicament product delivered. Variable timing mechanisms are envisaged for achieving such customisation.

Delivery of the combination product (e.g. after mixing) to the patient is preferably through a single outlet. The outlet is typically positioned to be in communication with the distinct medicament dose portions delivered. The outlet may have any suitable form. In one aspect, it has the form of a mouthpiece and in another, it has the form of a nozzle for insertion into the nasal cavity of a patient.

The outlet is preferably a single outlet, which communicates with the distinct medicament dose portions delivered via a common air channelling means (e.g. formed as an air-pipe or common manifold). The patient may therefore breathe in through a single outlet, and that breath be transferred through the common channelling means to (all of) the released medicament dose portions, thereby enabling their inhalation as a multi-active combined product.

In addition to, or as an alternative to, any separate mixing chamber, the outlet and/or channelling means may be shaped to encourage mixing of medicament as a result of the air flow created by inhalation by the patient. For example, baffles or other mechanical aids to mixing may be incorporated. Venturi channelling of the airflow is also envisaged in embodiments. Helical form channels are envisaged.

Suitably, the medicament dispenser is provided with at least one actuation indicator associated with the first medicament container and the at least one further medicament container. The association may be direct, or it may be through some form of intermediary component such as a coupling component.

The term ‘actuation indicator’ is used herein to mean any means for indicating, or in particular counting, when the dispenser device is actuated. That indication may be based on detection of any actuation step, which will result in delivery of medicament from the dispenser device or it may be based on detection of the medicament released by an actuation step.

The actuation indicator particularly includes means for registering and displaying dose release or dose count information to the patient. At a basic level, that information may simply relate to the fact that an actuation step or medicament release has been detected, but more often the information relates to the number of doses delivered or remaining of each medicament in the dispenser device. The information may be delayed in digital or analogue form, typically using standard count indicia (e.g. ‘999’ to ‘000’ indicia count display). Embodiments involving either ‘counting up’ or ‘counting down’ in increments are envisaged.

Dose release or dose count information may be displayed for the ‘combined product’ (i.e. first and at least one further medicament) together, or it may be separately displayed for each separate medicament component of the combination.

When an actuation (step) is to be detected, the medicament dispenser suitably comprises an actuation sensor. The actuation sensor is for example, sensitive to parameters selected from the group consisting of electro magnetic radiation, magnetic field, light, motion, temperature, pressure, sound, oxygen concentration, carbon dioxide concentration and moisture. The actuation sensor is arranged to sense the actuation of the dispenser. In one aspect, the actuation sensor is integral with the housing, for example moulded into a housing of the dispenser device or attached thereto. Alternatively, the actuation sensor is reversible attachable to the housing.

Where release of medicament is to be detected, each actuation indicator suitably comprises a release sensor for directly detecting the medicament release. The positioning of the release sensor in the dispenser device will be arranged to maximise detection of each, whilst minimising any interference effects (including those due to release of other medicament) and whilst minimising any effect on the delivery of each medicament to the patient.

The actuation indicator may be associated mechanically or electronically with the actuation or release sensor(s), such that when the detector detects actuation or medicament release a signal is sent to the actuation indicator to record that a (part) dose has been dispensed.

In one aspect, the actuation indicator comprises a microprocessor. Suitably, the microprocessor performs operations on the data from any sensor and produces a signal output relating to the data or the outcome of an operation on the data.

Suitably, the actuation indicator additionally comprises a visual display unit for display of the data. Preferably, the visual display unit displays the number of doses of medicament used or remaining within the container. Preferably the doses are displayed numerically, by a series of coloured lights or by a monochrome bargraph.

Suitably, the actuation indicator transmits actuation data to the electronic data management system.

Suitably, the device additionally comprises a shake detector for detecting shaking of the medicament container (e.g. prior to actuation of the dispensing mechanism), wherein said shake detector transmits shake data to the electronic data management system.

Suitably, any actuation detector, release detector, or shake detector comprises a sensor for detecting any suitable parameter such as movement. Any suitable sensors are envisaged including the use of optical sensors. The release detector may sense any parameter affected by release of the medicament such as pressure, temperature, sound, moisture, carbon dioxide concentration and oxygen concentration.

Suitably, the medicament dispenser is actuable in response to the inward breath of a patient and includes a breath sensor of any suitable type (e.g. mechanical or electronic) for detecting that inward breath wherein the sensor communicates with the electronic control system. Thus, in use the patient breathes in through the dispenser (e.g. through the mouthpiece); the breath is detected by the breath sensor; the sensor communicates with the electronic control system to convey an ‘inward breath detected’ signal; and the electronic control system responds by releasing medicament from one or more of the medicament containers for inhalation by the patient.

In one aspect, the breath sensor comprises a breath-movable element that is movable in response to the breath of a patient. Preferably, the breath-movable element is selected from the group consisting of a vane, a sail, a piston and an impeller.

In another aspect, the breath sensor comprises a pressure sensor for sensing the pressure profile associated with the breath of a patient.

In a further aspect, the breath sensor comprises an airflow sensor for sensing the airflow profile associated with the breath of a patient.

In a further aspect, the breath sensor comprises a temperature sensor for sensing the temperature profile associated with the breath of a patient.

In a further aspect, the breath sensor comprises a moisture sensor for sensing the moisture profile associated with the breath of a patient.

In a further aspect, the breath sensor comprises a gas sensor for sensing the oxygen or carbon dioxide profile associated with the breath of a patient.

In a further aspect, the breath sensor comprises a piezoelectric or piezoresistive element.

In one aspect, the dispenser additionally comprises a breath-responsive trigger for triggering one or all of the component medicament dispensers, said breath-responsive trigger being actuable in response to a trigger signal from the electronic control system or electronic data management system. Suitably, the electronic data management system includes a predictive algorithm or look-up table for deriving from the breath data when to transmit the trigger signal. For example, a real-time analysis of the patient breath waveform may be made and the trigger point derived by reference to that analysed waveform.

In one aspect, the medicament dispenser herein includes a timing control system for controlling the time of release of contents from the first and at least one further medicament container. The timing control system generally communicates with the electronic control system with which it may in aspects, form an integral part.

The timing control system is suitably arranged to vary the relative time of release of each medicament component from its respective medicament container. Each medicament component may therefore be arranged for simultaneous or sequential release, although in general where components are released sequentially the time delay between releases of each separate medicament component is short (e.g. milliseconds) to ensure that a combined product is provided for administration to the patient.

In a further aspect, by varying the time of release, the ratio of quantity of each medicament component released can also be varied, thereby enabling the provision and delivery of ‘tailored’ combined products.

The timing control system generally comprises electronic components and is arranged to be responsive to the electronic control system. In aspects, the timing control system is arranged to be responsive to a diagnostic system, which is arranged to diagnose patient disease characteristics and thereby select and deliver and suitable tailored combined product dose.

Any or all mechanical components of the dispenser may be driven by either an electronic or mechanical drive system or combination thereof.

Suitably electronic drive means typically comprise a motor, preferably an electrically-powered motor. The motor may provide linear or rotary drive, but in general, rotary motors are most suitable. The motor may for example, comprise a DC electric motor, a piezoelectric (PZ) motor, an ultrasonic motor, a solenoid motor or a linear motor. Preferably, the electronic drive system comprises a DC motor, a PZ motor or an ultrasonic motor.

The use of ultrasonic motors is particularly preferred since they offer advantages over conventional motors in terms of weight, size, noise, cost and torque generated. Ultrasonic motors are well known in the art and are commercially available (e.g. BMSTU Technological Cooperation Centre Ltd, Moscow, Russia; Shinsei Corporation, Tokyo, Japan).

Ultrasonic motors do not use coils or magnets but comprise a piezo-electric ceramic stator that drives a coupled rotor. The stator generates ultrasonic vibrations, which in turn causes rotation of the rotor. While regular DC motors are characterised by high speed and low torque, requiring reduction gearing to increase torque, ultrasonic motors attain low speed and high torque, thus eliminating the need for reduction gearing. Furthermore, these motors are lightweight and compact, lacking coils and magnets, and are noiseless as the ultrasonic frequencies used are not audible to the human ear.

Suitably, the device further comprises actuating means for actuating said electronic drive system. Said actuating means may take the form of a switch, push-button, or lever.

The constituent medicaments of the plural medicament components suitably, in combination comprise a combination medicament product. Suitably the medicaments are selected from the group consisting of albuterol, salmeterol, fluticasone propionate and beclomethasone dipropionate and salts or solvates thereof. Preferably, the combination comprises salmeterol xinafoate and fluticasone propionate.

### BRIEF DESCRIPTION OF THE DRAWINGS

The invention will now be described in more detail with reference to the following drawings:

FIGS. 1A, 1B and 1C show schematic representations of a medicament dispenser herein where a diagnostic detecting means is integrated with the whole dispenser device, the detecting means is as an attachment to the dispenser device, and the detecting means is remote to the dispenser device;

FIG. 2 shows a schematic diagram of the various system aspects of a medicament dispenser herein;

FIG. 3 shows a perspective side view of a medicament dispenser herein that may be adapted to have MDI or DPI form;

FIG. 4 shows a perspective side view of the medicament dispenser of FIG. 3 in association with a docking station therefor;

FIG. 5 shows a block diagram of the workings of the medicament dispenser of FIG. 3 as adapted to have either MDI or DPI form;

FIG. 6 shows in perspective view the inner workings of the medicament dispenser of FIG. 3 as adapted to have dual MDI form;

FIG. 7 shows in perspective view the inner workings of the medicament dispenser of FIG. 3 as adapted to have dual DPI form; and

FIGS. 8a to 8c show various perspective views of a dry powder capsule for use with the DPI form medicament dispenser of FIG. 7.

### DETAILED DESCRIPTION OF THE DRAWINGS

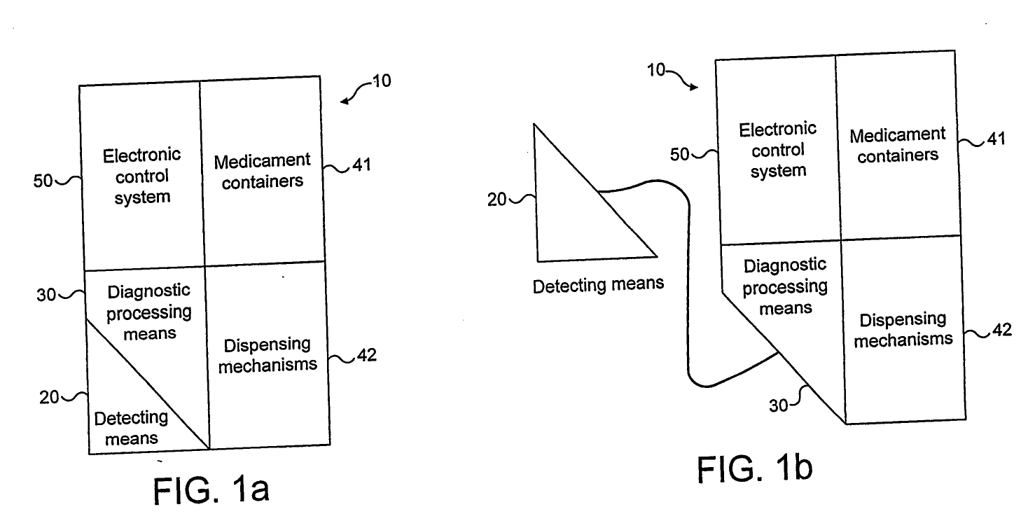

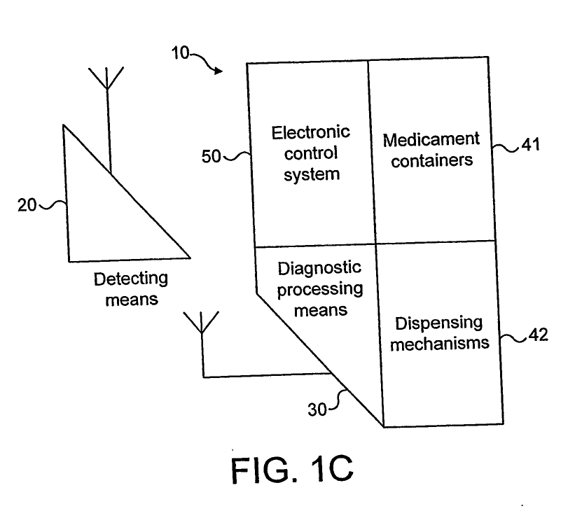

FIGS. 1A, 1B and 1C all show a schematic representation of a medicament dispenser in accord with the invention. The medicament dispenser 10 comprises diagnostic detecting means 20, electronic diagnostic processing means 30 and medicament dispensing means comprising plural medicament containers 41 and dispensing mechanisms 42. The detecting means comprises a sampling means (not shown) for example a mouthpiece into which a patient exhales. Specified chemical and/or physical characteristics of the exhaled breath are detected by the detecting means 20 and the data processed by the electronic processing means 30. The electronic diagnostic processing means 30 communicates with the electronic control system 50 to determine the required quantity of each medication. Dispensing mechanisms 42 dispense the medication from each medicament container 41 to the patient in relative ratios determined by the electronic control system 50. In some cases, the medicament containers 41 and/or dispensing mechanisms 42 may be physically integrated with part of the detection means 20, e.g. a shared mouthpiece.

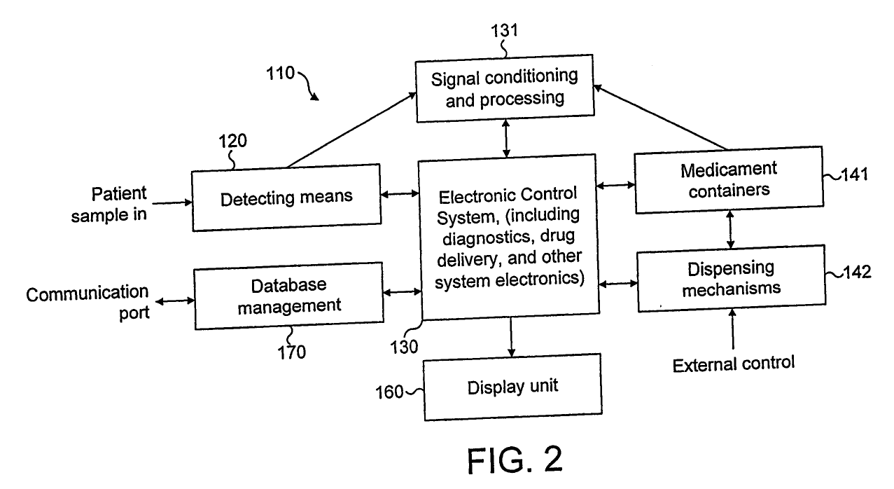

FIG. 2 shows a schematic functioning diagram of the system 110 of the medicament dispenser. The detecting means 120 may contain one or more sensors operable by any suitable principles, including those for patient diagnostics sensing and those for feedback for device control and referencing purposes. In the case of an inhalation device, the detecting means is usually housed in a mouthpiece. The signal conditioning and processing unit 131 includes signal pre-amplification and other necessary signal modification circuits before its converting to digital signal by control electronics unit 130 (via A/D interface). This is a key unit consisting of micro controller and affiliated electronics. The control electronic unit 130 receives measurement signals, system control feedback, such as temperature, medicament remaining in each medicament container, actuator states, and others system parameters sending back by various sensors in the system. All the information is processed according the electronic control system that tells the unit 130 to take appropriate actions in responding to particular input signals. It also controls system display unit 160 to display proper messages for user, and communicates with other systems via telecommunication interface. It interacts with database management software 170 to allow sensed diagnostic data to be organised appropriately and to extract information required to determine disease severity or dose required to deliver etc. The medicament containers 141 are basically medicament storage facilitators with necessary sensors and actuators controllable by the micro-controller. Drug dispensing mechanisms 142 are (micro) mechanical or electro-mechanical actuation systems, which will respond to the micro-controller's signal to adjust drug-dispensing volume and activate subsequent delivery actions, thereby enabling delivery of tailored combination product.

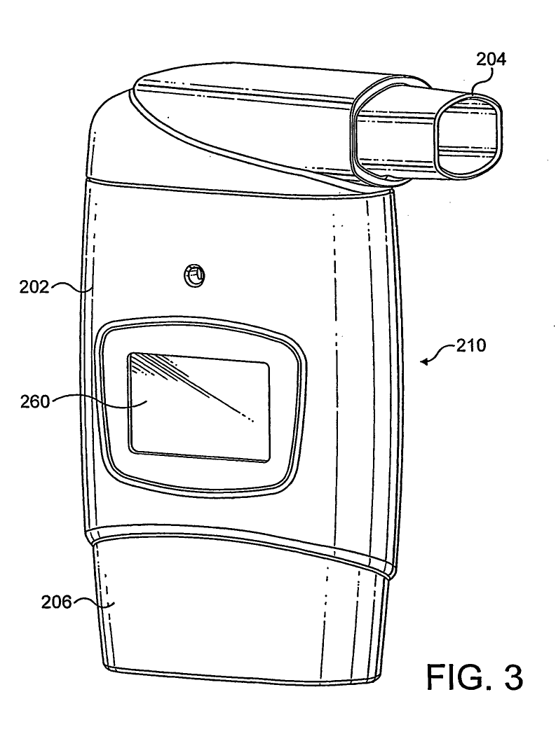

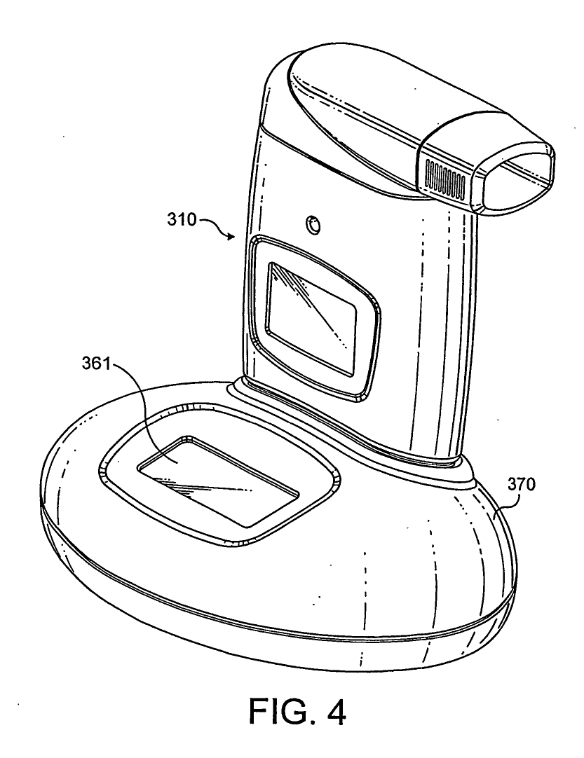

FIG. 3 shows a perspective side view of a medicament dispenser 210 herein that may be adapted to have metered dose inhaler (MDI) or dry powder inhaler (DPI) form (as will be illustrated in later FIGS. 4 to 8a). The dispenser 210 comprises a housing 202 adapted for ease of grip by a user. The housing 202 is provided with a mouthpiece 204 for inhalation of medicament by a patient. The housing 202 is also provided with a display 260 to display information to the patient from an electronic control system (illustrated in later drawings). The lower stem 206 of the housing 202 is shaped for receipt by a docking station (see FIG. 4) for electronic transfer of information thereto.

FIG. 4 shows the medicament dispenser 310 of FIG. 3 in docked relationship with docking station 370. The docking station 370 includes an electronic data management system (not visible) and a display 361 for display of information to the patient. When in docked relationship, information is transferable electronically between the electronic control system of the medicament dispenser 310 and the data management system of the docking station 370 (e.g. via an infra red communications link). In aspects, the docking station is provided with further communications facilities to enable wired or wireless communication with a network computer system (e.g. the Internet via a modem).

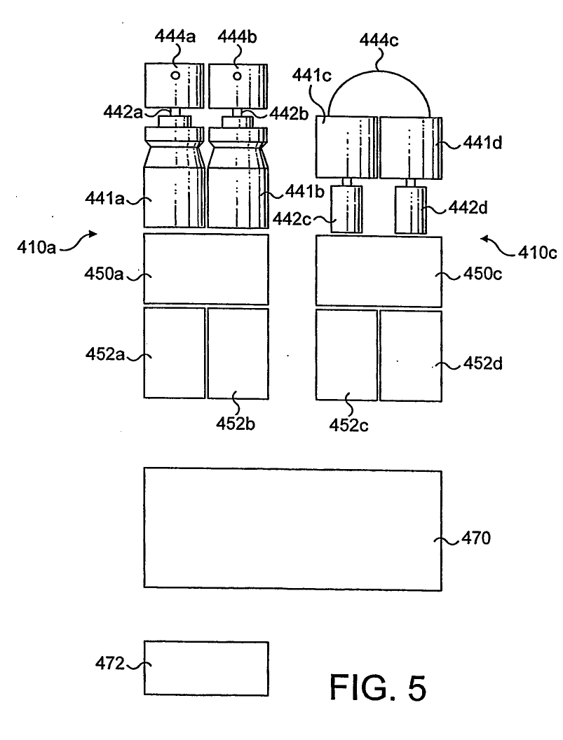

FIG. 5 shows a block diagram representation of the component features of the medicament dispenser of FIG. 3 as adapted to have either dual MDI (left hand part of diagram) or dual DPI form (right hand part of diagram).

Dealing initially with the MDI form 410a, the key component features may be seen to comprise side-by-side mounted aerosol containers 441a, 441b, each provided with a dispensing valve 442a, 442b adapted to co-operate with a nozzle block 444a, 444b. It will be appreciated that dispensing of aerosol form medicament from the aerosol containers 441a, 441b is achievable in the conventional way by moving the valves 442a, 442b thereof towards the (fixed) nozzle blocks 444a, 444b thereby triggering release of aerosol form medicament through the valves 442a, 442b.

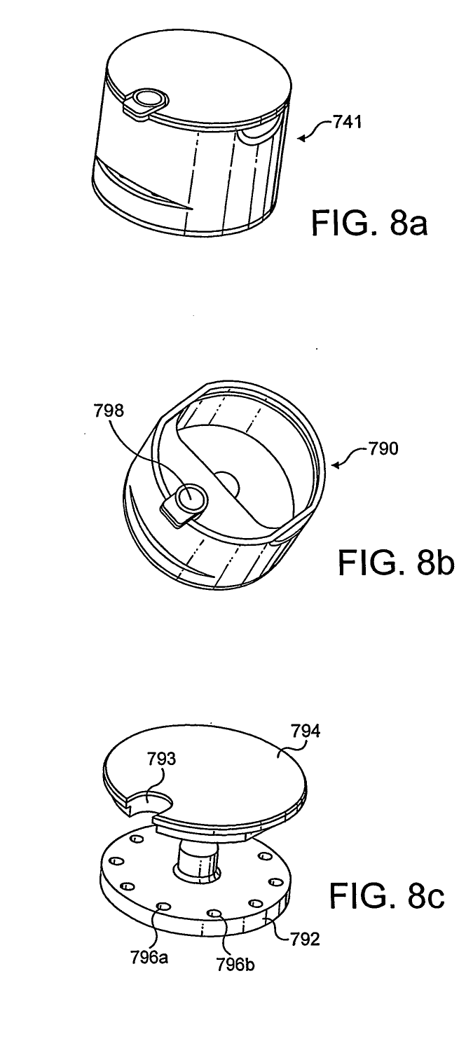

Dealing now with the DPI form 410c which may be seen to comprise side-by-side mounted dry powder capsules 441c, 441d, each provided with motor drives 442c, 442d for rotation of each respective capsule 441c, 441d from a ‘closed’ position to a ‘release’ position in which powder form medicament is releasable from the capsules 441c, 441d (a more detailed description of the structure of the capsules 441c, 441d is provided in FIGS. 8a to 8c). It will be appreciated that delivery of powder form medicament from the capsules 441a, 441b (when in the release position) occurs in response to the inward breath of a patient which acts such as to aerosolise the medicament such that it may be inhaled through exist duct 444c.

Both the MDI and DPI form versions of FIG. 5 are also provided with a printed circuit board (PCB) 450a, 450c for accommodating the electronic circuitry of the electronic control system and batteries 452a-d to power the electronics. The dispenser (in either form) 410a, 410c is receivable by docking station 470 which is itself provided with a transceiver 472 for electronically transmitting and receiving information from the electronic control system 450a, 450c of the dispenser 410a, 410c (e.g. via an infra red communications link).

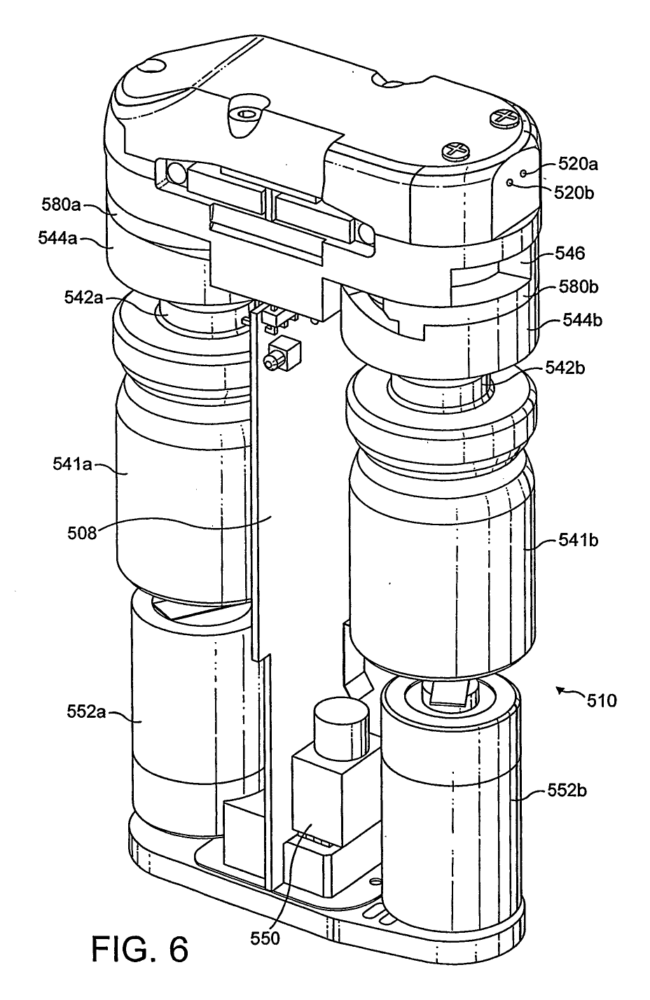

The dual MDI form of the medicament dispenser of FIGS. 3 and 5 is shown in more detail in FIG. 6. Inner frame 508 of the dispenser 510 may be seen to accommodate side-by-side mounted aerosol contajners 541a, 541b, each provided with dispensing valves 542a, 542b adapted to co-operate with nozzle blocks 544a, 544b to enable the release of aerosol form medicament to exit passage 546 for inhalation by the patient. Each nozzle block 544a, 544b also has a solenoid rotary drive 580a, 580b in cam relationship therewith and arranged such that on rotary actuation of the drives 580a, 580b each nozzle block is forced downwards thereby actuating its associated dispensing valve 542a, 542b from which aerosol form medicament is released. It will be appreciated that the release of medicament would be via a mouthpiece 204 (as shown in FIG. 3) to the patient.

Within the mouthpiece 204 area, there are also provided sensors 520a, 520b for sensing air pressure and air flow through the mouthpiece thereby enabling detection of a patient's inward breath. The sensors 520a, 520b communicate with electronic control system 550 comprised as circuitry on a PCB and powered by batteries 552a, 552b.

In use, the patient places the mouthpiece 204 into his mouth and breathes in. The resulting pressure and airflow change is registered by the sensors 520a, 520b that communicate this information to the electronic control system 550. Once a threshold has been passed, the electronic control system 550 sends a ‘fire’ signal to each solenoid drive 580a, 580b which drivably rotates and, as a result of having a cam relationship to its related nozzle block 544a, 544b, transmits downward force to the nozzle blocks 544a, 544b to release medicament from the medicament containers 541a, 541b through their respective valves 542a, 542b. A combination medicament product (i.e. one comprising medicament portions from both of the medicament containers 541a, 541b) is thereby delivered to the exit passage 546 for inhalation by the patient.

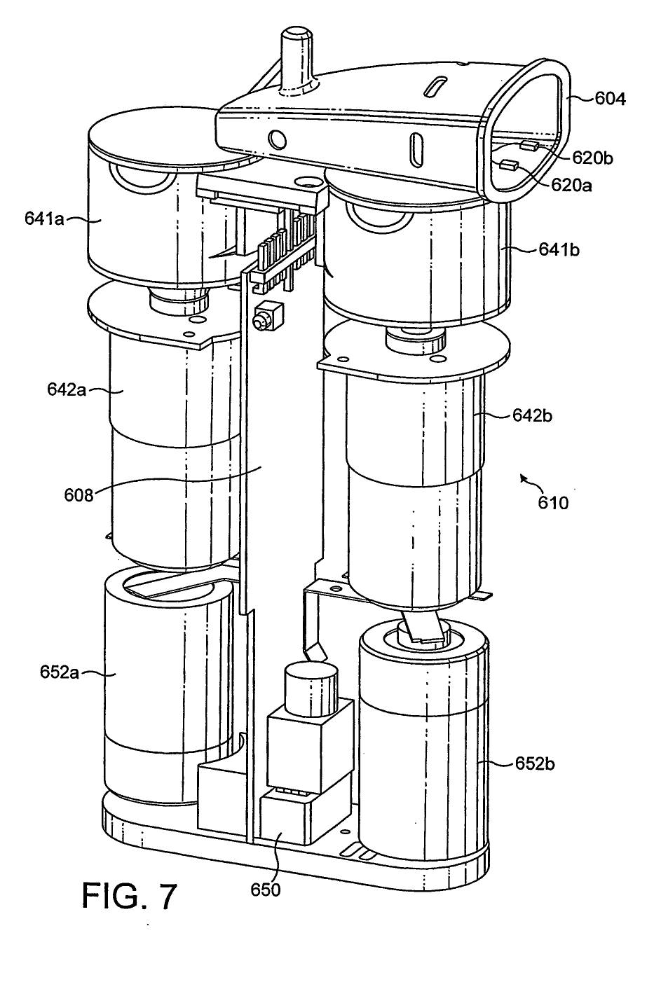

The dual DPI form of the medicament dispenser of FIGS. 3 and 5 is shown in more detail in FIG. 7. Inner frame 608 of the dispenser 610 may be seen to accommodate side-by-side mounted dry powder capsules 641a, 641b, each provided with rotary drives 642a, 642b for rotation of each respective capsule 641a, 641b from a capsule closed position to a dispensing position in which powder form medicament is releasable from the capsules 641a, 641b (a more detailed description of the capsule structure 641c, 641d is provided in FIGS. 8a to 8c). Release of medicament to the patient is via a mouthpiece 604.

Within the mouthpiece 604 area, there are also provided sensors 620a, 620b for sensing air pressure and air flow through the mouthpiece 604 thereby enabling detection of a patient's inward breath. The sensors 620a, 620b communicate with electronic control system 650 comprised as circuitry on a PCB and powered by batteries 652a, 652b.

In use, the patient places the mouthpiece 604 into his mouth and breathes in. The resulting pressure and airflow change is registered by the sensors 620a, 620b that communicate this information to the electronic control system 650. Once a threshold is passed, the electronic control system 650 sends a ‘fire’ signal to each rotary drive 642a, 642b which drivably rotates its respective capsule 641a, 641b from a closed position to a release position in which powder form medicament is releasable from the capsules 641a, 641b. A combination dry powder medicament product (i.e. one comprising medicament portions from both medicament capsules 641a, 641b) is thereby made available for delivery to the patient. Delivery of medicament from the capsules 641a, 641b (when in the release position) occurs in response to the inward breath of the patient that aerosolises the dry powder medicament such that it may be inhaled through the mouthpiece 604.

FIGS. 8a to 8c show various perspective views of a dry powder capsule 741 for use with the DPI form medicament dispenser of FIG. 7. The dry powder capsule (as shown assembled in FIG. 8a) has two principal component parts, namely the housing 790 (shown in FIG. 8b) and the carrier disc 792 with lid 794 (shown in FIG. 8c). The carrier disc 792 has plural indents 796a, 796b provided thereto in circular configuration, wherein each indent 796a, 796b is capable of being loaded with a volume of dry powder medicament. The lid 794 has access hole 793 provided thereto. When assembled, the lid 794 is in fixed relationship to the housing 790, but the carrier disc 792 is rotatable therewithin to enable serial movement of each medicament-carrying indent 796a, 796b to a medicament release position. The release position is determined by the relationship of the respective indent 796a, 796b to release tube 798, which protrudes through lid access hole 793 and contacts the disc 792. When an indent 796a on the disc 792 is in registration with the release tube 798, medicament is releasable from that indent 796a (alone) to the release tube 798 and thence to the patient. It will thus be appreciated that release of medicament from each indent 796a, 796b in turn is achievable by progressive rotation of the disc 792 to serially bring each indent 796a, 796b into registration with the release tube 798.

Whilst, the dispenser of FIGS. 3 to 7 has been described in either dual MDI or dual DPI it will be appreciated that the control and actuation mechanisms are similar and therefore that a variation involving a combination MDI/DPI or indeed other combinations of different inhaler types could be achieved by workshop modification.

It may be appreciated that any of the parts of the dispenser device or any part thereof which contacts medicament may be coated with materials such as fluoropolymer materials (e.g. PTFE or FEP) which reduce the tendency of medicament to adhere thereto. Any movable parts may also have coatings applied thereto which enhance their desired movement characteristics. Frictional coatings may therefore be applied to enhance frictional contact and lubricants (e.g. silicone oil) used to reduce frictional contact as necessary.

The medicament dispenser of the invention is suitable for dispensing medicament combinations, particularly for the treatment of respiratory disorders such as asthma and chronic obstructive pulmonary disease (COPD), bronchitis and chest infections.

Appropriate medicaments may thus be selected from, for example, analgesics, e.g., codeine, dihydromorphine, ergotamine, fentanyl or morphine; anginal preparations, e.g., diltiazem; antiallergics, e.g., cromoglycate (e.g. as the sodium salt), ketotifen or nedocromil (e.g. as the sodium salt); antiinfectives e.g., cephalosporins, penicillins, streptomycin, sulphonamides, tetracyclines and pentamidine; antihistamines, e.g., methapyrilene; anti-inflammatories, e.g., beclomethasone (e.g. as the dipropionate ester), fluticasone (e.g. as the propionate ester), flunisolide, budesonide, rofleponide, mometasone e.g. as the furoate ester), ciclesonide, triamcinolone (e.g. as the acetonide) or 6α, 9α-difluoro-11β-hydroxy-16α-methyl-3-oxo-17α-propionyloxy-androsta-1, 4-diene-17β-carbothioic acid S-(2-oxo-tetrahydro-furan-3-yl) ester; antitussives, e.g., noscapine; bronchodilators, e.g., albuterol (e.g. as free base or sulphate), salmeterol (e.g. as xinafoate), ephedrine, adrenaline, fenoterol (e.g. as hydrobromide), formoterol (e.g. as fumarate), isoprenaline, metaproterenol, phenylephrine, phenylpropanolamine, pirbuterol (e.g. as acetate), reproterol (e.g. as hydrochloride), rimiterol, terbutaline (e.g. as sulphate), isoetharine, tulobuterol or 4-hydroxy-7-[2-[[2-[[3-(2-phenylethoxy)propyl]sulfonyl]ethyl]amino]ethyl-2(3H)-benzothiazolone; adenosine 2a agonists, e.g. 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g. as maleate); α₄ integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxyl) acetyl]amino}pentanoyl)amino]propanoic acid (e.g. as free acid or potassium salt), diuretics, e.g., amiloride; anticholinergics, e.g., ipratropium (e.g. as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagon; vaccines, diagnostics, and gene therapies. It will be clear to a person skilled in the art that, where appropriate, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament.

Preferred components of the combinations comprise medicaments selected from albuterol, salmeterol, fluticasone propionate and beclomethasone dipropionate and salts or solvates thereof, e.g., the sulphate of albuterol and the xinafoate of salmeterol.

Preferred components of combinations of active ingredients contain a bronchodilator in combination with an anti-inflammatory. The bronchodilator is suitably a beta-agonist, particularly a long-acting beta-agonist (LABA). Suitable bronchodilators include salbutamol (e.g., as the free base or the sulphate salt), salmeterol (e.g., as the xinafoate salt) and formoterol (eg as the fumarate salt). The anti-inflammatory is suitably an anti-inflammatory steroid. Suitably anti-inflammatory compounds include a beclomethasone ester (e.g., the dipropionate), a fluticasone ester (e.g., the propionate) or budesonide or any salt or solvate thereof. One preferred combination of components comprises fluticasone propionate and salmeterol, or any salt or solvate thereof (particularly the xinafoate salt). A further combination of components of particular interest is budesonide and formoterol or any salt or solvate thereof (e.g. formoterol as the fumarate salt).

The medicament or medicament formulation may take any form e.g. liquid, powder, tablet, and aerosol suspension. Preferably, the medicament is formulated as a dry powder or aerosol suspension formulation.

Generally, powdered medicament particles suitable for delivery to the bronchial or alveolar region of the lung have an aerodynamic diameter of less than 10 micrometers, preferably less than 6 micrometers. Other sized particles may be used if delivery to other portions of the respiratory tract is desired, such as the nasal cavity, mouth or throat. The medicament may be delivered as pure drug, but more appropriately, it is preferred that medicaments are delivered together with excipients (carriers) which are suitable for inhalation. Suitable excipients include organic excipients such as polysaccharides (i.e. starch, cellulose and the like), lactose, glucose, mannitol, amino acids, and maltodextrins, and inorganic excipients such as calcium carbonate or sodium chloride. Lactose is a preferred excipient.

Particles of the powdered medicament and/or excipient may be produced by conventional techniques, for example by micronisation, milling or sieving. Additionally, medicament and/or excipient powders may be engineered with particular densities, size ranges, or characteristics. Particles may comprise active agents, surfactants, wall forming materials, or other components considered desirable by those of ordinary skill.

The excipient may be included with the medicament via well-known methods, such as by admixing, co-precipitating and the like. Blends of excipients and drugs are typically formulated to allow the precise metering and dispersion of the blend into doses. A standard blend, for example, contains 1300 micrograms lactose mixed with 50 micrograms drug, yielding an excipient to drug ratio of 260:1. Dosage blends with excipient to drug ratios of from 100:1 to 1:1 may be used. At very low ratios of excipient to drug, however, the drug dose reproducibility may become more variable.

Aerosol formulations suitable for use with metered dose inhaler (MDI) dispensers typically comprise a propellant. Suitable propellants include P11, P114 and P12, and the CFC-free hydrofluoroalkane propellants HFA-134a and HFA-227.

The MDI aerosol formulation may additionally contain a volatile adjuvant such as a saturated hydrocarbon for example propane, n-butane, isobutane, pentane and isopentane or a dialkyl ether for example dimethyl ether. In general, up to 50% w/w of the propellant may comprise a volatile hydrocarbon, for example 1 to 30% w/w. However, formulations, which are free or substantially free of volatile adjuvants are preferred. In certain cases, it may be desirable to include appropriate amounts of water, which can be advantageous in modifying the dielectric properties of the propellant.

A polar co-solvent such as C₂₋₆ aliphatic alcohols and polyols e.g. ethanol, isopropanol and propylene glycol, preferably ethanol, may be included in the MDI aerosol formulation in the desired amount to improve the dispersion of the formulation, either as the only excipient or in addition to other excipients such as surfactants. Suitably, the drug formulation may contain 0.01 to 30% w/w based on the propellant of a polar co-solvent e.g. ethanol, preferably 0.1 to 20% w/w e.g. about 0.1 to 15% w/w. In aspects herein, the solvent is added in sufficient quantities to solubilise the part or all of the medicament component, such formulations being commonly referred to as solution formulations.

A surfactant may also be employed in the MDI aerosol formulation. Examples of conventional surfactants are disclosed in EP-A-372,777. The amount of surfactant employed is desirable in the range 0.0001% to 50% weight to weight ratio relative to the medicament, in particular, 0.05 to 5% weight to weight ratio.

The final aerosol formulation desirably contains 0.005-10% w/w, preferably 0.005 to 5% w/w, especially 0.01 to 1.0% w/w, of medicament relative to the total weight of the formulation.

The device of the invention is in one aspect suitable for dispensing medicament for the treatment of respiratory disorders such as disorders of the lungs and bronchial tracts including asthma and chronic obstructive pulmonary disorder (COPD). In another aspect, the invention is suitable for dispensing medicament for the treatment of a condition requiring treatment by the systemic circulation of medicament, for example migraine, diabetes, pain relief e.g. inhaled morphine.

Accordingly, there is provided the use of a device according to the invention for the treatment of a respiratory disorder, such as asthma and COPD. Alternatively, the present invention provides a method of treating a respiratory disorder such as, for example, asthma and COPD, which comprises administration by inhalation of an effective amount of medicament product as herein described from a device of the present invention.

It will be understood that the present disclosure is for the purpose of illustration only and the invention extends to modifications, variations and improvements thereto.

The application of which this description and claims form part may be used as a basis for priority in respect of any subsequent application. The claims of such subsequent application may be directed to any feature or combination of features described therein. They may take the form of product, method or use claims and may include, by way of example and without limitation, one or more of the following claims:

1. A medicament dispenser for use in the delivery of a combination medicament product to a patient, the dispenser comprising:
a first medicament container for containing a first medicament component;
a first release means for releasing the contents of said first medicament container;
at least one further medicament container for containing at least one further medicament component; and
at least one further release means for releasing the contents of each said at least one further medicament container;
wherein the first medicament component is kept separate from the at least one further medicament component until the point of release thereof for delivery in combination, and wherein the dispenser additionally comprises:
an electronic control system for controlling the release of contents from the first and at least one further medicament container.

2. A medicament dispenser according to claim 1, wherein the first medicament component and the at least one further medicament component are non-identical.

3. A medicament dispenser according to claim 1, comprising the first medicament container and only one further medicament container.

4. A medicament dispenser according to claim 1, wherein said first release means and said at least one further release means are independently operable.

5. A medicament dispenser according to claim 1, wherein said first release means and said at least one further release means are operable in coupled fashion.

6. A medicament dispenser according to claim 1, wherein any or either of the first and the at least one further medicament containers are provided to the medicament dispenser as reversibly removable refills.

7. A medicament dispenser according to claim 1, wherein the electronic control system includes input means for inputting control commands thereto.

8. A medicament dispenser according to claim 1, wherein the electronic control system includes a diagnostic system for collecting diagnostic information relating to patient disease condition.

9. A medicament dispenser according to claim 8, wherein the electronic control system and diagnostic system are integral.

10. A medicament dispenser according to claim 8, wherein the diagnostic system is separate from the medicament dispenser and communication means are provided to enable communication of data between the diagnostic system and the electronic control system.

11. A medicament dispenser system according to claim 1, additionally comprising an electronic data management system integral with or in communication with the electronic control system.

12. A medicament dispenser according to claim 11, wherein the electronic data management system comprises a memory for storage of data; a microprocessor for performing operations on said data; and a transmitter for transmitting a signal relating to the data or the outcome of an operation on the data.

13. A medicament dispenser according to claim 11, wherein the electronic data management system additionally comprises a data input system for user input of data to the electronic data management system.

14. A medicament dispenser according to claim 11, additionally comprising a visual display unit for display of data from the electronic data management system to the patient.

15. A medicament dispenser according to claim 11, additionally comprising a datalink for linking to a local data store to enable communication of data between the local data store and the electronic data management system.

16. A medicament dispenser according to claim 1, wherein the first medicament container and/or the at least one further medicament container comprise a reservoir and a meter for metering medicament from said reservoir.

17. A medicament dispenser according to claim 16, wherein the meter comprises at least one metering cavity or chamber.

18. A medicament dispenser according to claim 17, wherein the or each metering chamber is reversibly moveable into fluid communication with the reservoir for metering therefrom.

19. A medicament dispenser according to claim 1 to 18, additionally comprising mixing means for mixing the released medicament components prior to their delivery to the patient as a combination product.

20. A medicament dispenser according to claim 19, wherein the mixing means comprises a mixing chamber including inlets for receiving medicament form the first medicament container and at least one further medicament container; and an outlet for delivery of combination medicament product for delivery to the patient.

21. A medicament dispenser according to claim 1, additionally comprising variable release means responsive to the electronic control system for varying the amount of medicament product releasable from each medicament container.

22. A medicament dispenser according to claim 21, wherein the variable release means includes an timing control system for controlling the time of release of contents from the first and at least one further medicament container.

23. A medicament dispenser according to claim 1, additionally comprising an actuation indicator associated with the first medicament container and/or the at least one further medicament container.

24. A medicament dispenser according to claim 23, wherein said actuation indicator comprises an actuation sensor sensitive to a parameter selected from the group consisting of electro magnetic radiation, magnetic field, light, motion, temperature, pressure, sound, oxygen concentration, carbon dioxide concentration and moisture.

25. A medicament dispenser according to claim 1, wherein the medicament dispenser is in the form of an inhaler device.

26. A medicament dispenser according to claim 25, wherein the inhaler device is in the form of a device selected from the group consisting of a reservoir dry powder inhaler (RDPI), a multi-dose dry powder inhaler (MDPI), a metered dose inhaler (MDI), a liquid spray inhaler (LSI) and any hybrids thereof.

27. A medicament dispenser according to claim 25 comprising a single outlet for delivery of the combination medicament product to the respiratory tract of a patient.

28. A medicament dispenser according to claim 25, actuable in response to an inward breath of a patient.

29. A medicament dispenser according to claim 28, including a breath sensor for detecting said inward breath wherein the breath sensor communicates with the electronic control system.

30. A medicament dispenser according to claim 29, wherein the breath sensor comprises a breath-movable element that is movable in response to the inward breath of a patient.

31. A medicament dispenser according to claim 29, wherein the breath sensor is selected from the group consisting of a pressure sensor for sensing the pressure profile associated with the inward breath of a patient, an airflow sensor for sensing the airflow profile associated with the inward breath of a patient, a temperature sensor for sensing the temperature profile associated with the inward breath of a patient, a moisture sensor for sensing the moisture profile associated with the inward breath of a patient, a gas sensor for sensing the oxygen or carbon dioxide profile associated with the inward breath of a patient and any mixtures thereof.

32. A medicament dispenser according to claim 1, wherein the first medicament container contains a first medicament component and the at least one further medicament container contains at least one further medicament component.

33. A medicament dispenser according to claim 32, wherein said first medicament component comprises a bronchodilator and said at least one further medicament component comprises an anti-inflammatory.

34. A medicament dispenser according to claim 33, wherein said bronchodilator is a beta-agonist and said anti-inflammatory is a steroid.

35. A medicament dispenser according to claim 34, wherein said bronchodilator is selected from the group consisting of salbutamol, salmeterol, formoterol and any salts or solvates thereof and mixtures thereof.

36. A medicament dispenser according to claim 34, wherein said anti-inflammatory is selected from the group consisting of a beclomethasone ester, fluticasone ester, budesonide and any salt or solvates thereof and mixtures thereof.

37. (canceled)

38. A method of treating a respiratory disorder in a patient in need thereof comprising administering an effective amount of medicament suitable for treating said respiratory disorder to the patient by inhalation from a medicament dispenser according to claim 1.
